(19) United States
(12) Patent Application Publication
(10) Pub. No.: US 2008/0085696 A1
(43) Pub. Date: Apr. 10, 2008

(54) Emergency communication system utilizing available radio frequencies and telephone lines

(76) Inventors: Chad S. Salahshour, Mayfield Village, OH (US); Alexander D. Salahshour, Pepper Pike, OH (US); Joseph M. Salahshour, Pepper Pike, OH (US)

Correspondence Address: ROETZEL & ANDRESS, 1375 EAST 9TH STREET, CLEVELAND, OH, 44114, US

(21) Appl. No.: 11/644,522

(22) Filed: Dec. 22, 2006

Related U.S. Application Data
(60) Provisional application No. 60/850,524, filed on Oct. 10, 2006.

(51) Int. Cl. H04M 11/04

(52) U.S. Cl. 455/404.1

(57) ABSTRACT

An emergency communication system includes a combined transmitter and receiver device (transceiver) that transmits information from a residential or business location to an emergency response system, which in turn sends signals and communications to the transceiver via radio frequency (RF) signals. The transceiver performs certain functions in response and according to data transmitted by the emergency communication system. The transceiver device is connected to a standard telephone network and allows data to be processed by sending signals over the phone line. The transmitter device also acts as a receiver, as it is able to receive radio frequency (RF) signals. The RF signals can be sent from an emergency response system, or other types of notification networks. This emergency communication system thereby operates as a two way communication system utilizing current telecommunication technology.

### RELATED APPLICATION DATA

This application claims priority to previously filed U.S. Provisional Application No. 60/850,524 filed on Oct. 10, 2006 entitled “The Emergency Network Support System (TENSS)”. This application is hereby incorporated by reference in its entirety.

### BACKGROUND OF THE INVENTION

This invention relates to an emergency communication system. The system includes a combined transmitter and receiver device (transceiver) that transmits information from a residential or business location to an emergency response system, which in turn sends signals and communications to the transceiver via radio frequency (RF) signals. The transceiver performs certain functions in response and according to data transmitted by the emergency communication system. The transceiver device is connected to a standard telephone network and allows data to be processed by sending signals over the phone line. The transmitter device also acts as a receiver, as it is able to receive radio frequency (RF) signals. The RF signals can be sent from an emergency response system, or other types of notification networks. This emergency communication system thereby operates as a two way communication system utilizing current telecommunication technology.

### Combined Telephone and RF Communication

Utilization of phone lines and radio frequency signals for the transmission of data are well known. Various apparatus and system have been disclosed which allow for communication using phone and/or radio frequency for emergency and non-emergency situations. U.S. Pat. No. 6,510,207 utilizes both of these methods in an emergency alert system comprising several components. The system receives an emergency message via radio frequency and responds to the message via various outputs. The telephone is a part of this system and acts as a means of disseminating an emergency message by dialing a preset call list. U.S. Pat. No. 5,917,887 discloses a combined telephone and RF receiver configured to receive emergency alert signals and record corresponding emergency alert voice messages. U.S. Pat. No. 5,091,930 details a phone monitoring system which incorporates a radio frequency receiver as a backup.

Systems which automatically dial emergency response numbers based on a preprogrammed or sensed event are well known in the art. U.S. Pat. No. 4,064,368 discloses a notification system for alerting a preset phone number that a user has activated an emergency button, or failed to reset a timer. U.S. Pat. No. 4,417,100 discloses the use of a small transmitter which broadcasts a radio frequency to a receiver, the receiver being hooked into the phone system. This receiver then activates a calling feature which dials a preset number, alerting a party to an emergency type event. U.S. Pat. No. 5,710,803 discloses a notification device hooked into the phone system. Upon the activation of one of three buttons, the system dials police/fire/ambulance or another emergency number with a prerecorded message of the users choosing. U.S. Pat. No. 6,289,082 discloses the remote activation of a signal connected to a device incorporated into the telephone system. The device connects to a predetermined phone number and notifies the receiving party of a problem. U.S. Pat. No. 6,678,360 discloses a phone system which accumulates data during a users call. This data is utilized by the recipient to tailor a response or as a means of gathering information.

### Network-controlled Emergency Lighting

Lighted address displays are well known and provide a means for emergency personnel to quickly locate an address. The lighting of an address sign also serves as a warning to neighbors that the occupant of a residence may require assistance. The lighting for these systems is either a bulb behind a translucent panel, or an LED apparatus which lights the alphanumeric characters of the address. U.S. Pat. No. 4,611,265 discloses an address lighting apparatus that includes the ability to remotely turn the address light on from inside the house. U.S. Pat. No. 4,993,058 discloses a lighted address sign which automatically activates upon the dialing of 9-1-1 from the users phone while U.S. Pat. No. 4,931,780 details a similar device, but includes a flashing strobe and an audio alert. U.S. Pat. No. 6,568,109 details an address display which adjusts light output based on ambient light conditions. U.S. Pat. No. 7,012,544 discloses a backlit address sign and audio which varies output based on the nature of the situation.

In addition to address lights, the ability to signal a problem with regular lighting and other electrical devices provide an additional means for bringing attention to an emergency situation. U.S. Pat. No. 4,977,353 discloses an emergency lighting system for turning on various systems, including lights, upon the activation of a protocol. U.S. Pat. No. 5,621,379 discloses a lighting system which enables different colored lights based on the nature of emergency. Different light colors are lit based on the nature of the emergency (fire, ambulance, police, etc.). U.S. Pat. No. 5,838,771 discloses another system that enables a series of lights activated by dialing 9-1-1, or a similar activation code. U.S. Pat. No. 5,929,781 discloses a system for remotely testing emergency lights. U.S. Pat. No. 6,249,221 discloses an escape system for aiding a person in finding a door in an emergency situation such as a fire.

### Remote Home and Patient Monitoring

Home care monitor systems have improved the quality of life of home-based patients by allowing in home monitoring of vitals signs and other physiological parameters. These systems have also allowed for better efficiency on the part of health care providers since these parameters can be transmitted to remote locations such as doctors offices, hospitals and emergency responders. Such a transmittal provides emergency personnel with accurate readings for evaluations and diagnosis without the patient being physically present, or in the case of emergency personnel, while en route to administer treatment to the patient. U.S. Pat. Application US2004/0044545 discloses a home care monitoring system which monitors a patients blood sugar, blood pressure and heart rate. This data is then sent to a health care provider via a phone or modem. U.S. Pat. No. 5,335,664 discloses a wristwatch that monitors a patients vital signs and if those signs are outside a standard range, alerts emergency personnel via a device connected to a phone. U.S. Pat. No. 6,723,046 discloses a monitoring system for blood glucose, blood pressure and weight and a means of sending this data to a receiving unit at a medical care provider via a phone connection. U.S. Pat. No. 5,441,047 discloses an audio/video link between a caregiver and a patient which allows the caregiver to monitor the health and vital signs of a patient via a communication linkage such as a video camera and television set. U.S. Pat. No. 6,968,375 details a system for the remote monitoring of an individual based on a series of questions designed to generate a response, the answers being transmitted by a communication network. U.S. Pat. No. 5,553,609 discloses a computer based remote visual monitoring system for in-home patient care from a remote location via ordinary phone lines. The setup allows for audio/video monitoring and two-way communication.

Elderly persons living alone may be unable to summon help should they become incapacitated. If not attended to in a reasonable period of time, death or irreparable harm may result. U.S. Pat. No. 4,524,243 discloses a personal alarm system which notifies a monitoring station of a subscribers inactivity. The subscriber activates a switch or button on a predetermined basis and cessation of this action notifies the monitoring station of a potential problem and enables a predetermined response. U.S. Pat. No. 6,611,206 discloses a system which monitors the conditions of an elderly person via sensors in the person's residence. These sensors have the ability to detect mood swings, irregular behavior patterns or unrecognized persons and objects. Once a set of criteria are met, an alarm is sounded and video monitoring is begun. U.S. Pat. No. 5,689,240 discloses a system that transmits and receives signals. Once a user leaves a predetermined area, the transmission ceases and an alarm is signaled.

Elderly and/or handicapped persons subject to balance irregularities are at risk for broken hips from falls. In addition to trauma from the actual fall, any time delay in responding may multiply the detrimental effects of the fall. U.S. Pat. No. 6,433,690 discloses a method of monitoring the elderly for slips and/or falls. The user employs a belt device which causes an alarm once a predetermined angle is exceeded. The alarm can initiate a phone call or a paging device. U.S. Pat. No. 6,577,901 details a RF wireless device which transmits a patients vital signs to a predetermined location.

### Locator and Proximity Sensing

Locator and proximity devices are known in the prior art such as devices which announce when a person/device has entered a predetermined area. U.S. Pat. No. 6,262,660 discloses a locator system for determining when an object has entered a predetermined monitoring area. Such a devices announces via an audio signal that the object has entered the preset zone. U.S. Pat. No. 7,042,361 discloses a system for monitoring a child within a defined area by a transmitter/receiver device. U.S. Pat. No. 4,899,135 discloses a radio frequency monitoring system involving a transmitting unit carried by a child and a receiving unit carried by a child guardian. Upon separation of the two units an alarm is emitted. U.S. Pat. No. 6,847,295 discloses the same type of proximity devices, but incorporates a heartbeat monitor and an alert to authorities.

### Emergency Broadcastinq

The ability to broadcast via normal radio waves or radio frequencies (RF) has been known for decades as is the ability to specifically tailor this broadcast to one's needs. Also known is the ability to mass dial an emergency message via a standard phone line. U.S. Pat. No. 6,002,748 discloses the ability to notify a set of local telephone exchanges to a recorded warning message. U.S. Pat. No. 6,009,308 discloses a selective calling receiver which activates based on a correct matching of the callers phone number with a preset list and then processes the message being sent by the caller. Such a message may be an emergency message requesting help. U.S. Pat. No. 6,151,385 discloses a reverse 911 system where designated phone numbers are contacted and these phone numbers have specific devices for accepting phone calls. U.S. Pat. No. 6,594,345 discloses a system for providing early warning notifications to telephone subscribers having a calling number delivery service. U.S. Pat. No. 6,775,356 discloses a system which takes a phone call (wireless or wireline) and initiates an emergency response along with providing information regarding the caller and provides an output of a second call to a number of the users choice.

### Weather and Disaster Monitoring

Current radar and weather monitoring systems provide forecasts of existing weather systems. The monitoring of certain geological events is an expanding area of investment and interest as is the use by emergency personnel to disseminate information to persons in an affected area and assisting persons in evacuation and/or dealing with issues that arise from the emergency. U.S. Pat. No. 6,914,525 discloses an alert system pertaining to geographical and/or natural disasters. The telecommunication network monitors data in disaster prone areas and alerts persons within the monitored area to potential problems. Wireless sensor modules are located within monitored areas and allow for continuous collection of data. U.S. Pat. No. 5,742,914 discloses an apparatus for determining/recording the location of a vehicle and the status of a load on that vehicle.

### Emergency Mapping

The use of digital maps is commonplace in today's society as applications expand. Systems are available on automobiles and trucks which allow a person to access information in a stored medium and correlate that data with their location via a GPS (global positioning system). Optimized routes for a truck driver or the route for a lost motorist to find their way back to a location are valuable resources. Digital maps offer luxuries over a paper map including the ability to highlight an area, and provide additional information on a particular zone. U.S. Pat. No. 7,103,854 details a system and method for manipulating digital map information from a graphical or text window. By highlighting an area, the user can access additional information regarding their selection. U.S. Pat. No. 6,816,878 discloses a notification system which utilizes the telephone to notify subscribers upon the triggering of an event. The geographical location of the user determines whether that subscriber is contacted. U.S. Pat. No. 6,509,833 discloses a telecommunication system which provides a warning to subscribers, the type of warning based on the nature of the emergency or event. U.S. Pat. No. 6,112,074 discloses a radio communication system wherein the subscriber is notified of an event/emergency in their area. The areas of broadcast can be broken into zones, thereby allowing broadcast only to a portion of a network.

### RF Emergency Broadcasting

An alarm system which employs a radio frequency transmitter and a frequency compatible receiver that couples into a telephone system to ring a remote telephone and deliver a message is known in the art. U.S. Pat. No. 4,219,698 discloses an alarm system which receives a signal via RF, the signal then activating the touch tone dialing of a predetermined number and delivering an appropriate emergency method.

The broadcasting of Radio Frequency (RF) emergency response signals or messages to multiple receivers over a geographic area is known in the art. U.S. Pat. No. 4,415,771 discloses a public alert and advisory system for communication of information from a central location to a plurality of remote locations. This system utilizes standard AM/FM/TV stations, but sends the information via a second modulation technique, which differs from the standard modulation technique. U.S. Pat. No. 6,801,764 details a broadband system for managing data communication from a mobile platform. Such a tool could be utilized during emergencies and other necessary events. U.S. Pat. No. 7,102,514 details a method for detecting biological/chemical/nuclear attacks near large cities. The system collects real time data and notifies a central database when levels are exceeded. At that point current weather data can be used to determine air/temperature effects of the attack.

A portable unit is useful to broadcast and/or receive data in the event of an emergency. Such a unit would allow emergency personnel to broadcast directly from the site of an accident. U.S. Pat. No. 5,572,201 discloses a warning system for alerting a person to an emergency situation via an RF signal. A tunable receiver converts an alarm signal into an acoustic signal.

### Electronic Identification Number Matching Capabilities

The ability to utilize an electronic identification number unique to an individual unit is well known in the art. A cell phone possesses a unique electronic identifier that allows some calls to be placed to the user, while other calls not intended for the user are by-passed. Another example of selective RF transmission involves a standard radio. Based on how/where a radio is tuned/dialed, certain frequencies are received, while others are bypassed. An expansion of these two ideas is a new approach, as the ability to combine a standard RF broadcast with the reception of selective RF transmissions is needed in the art. Such a unit would allow a wide ranging broadcast from current RF means, and identify via the electronic identification number whether the individual unit reacts to this broadcast. The invention combines these types of RF transmissions with telephone land line communication in a home-based device for emergency and convenience communications.

### SUMMARY OF THE INVENTION

The present invention generally relates to an emergency communication system comprising a transmission device for sending information from a location to an emergency response system, the transmission device being connected to a standard phone network, a data processing means operating by sending signals over the standard phone network from the transmission device to the emergency response system, a reception device for receiving information via radio frequency signals, the reception device having a unique electronic identification number, the transmission device having the unique electronic identification number, a data transmittal means operating by sending radio frequency signals from the emergency response system to the reception device, the reception device using the electronic identification number in determining the relevancy of the radio frequency signal to the reception device, an output means of the reception device operating when relevant radio frequency signals are received; and the transmission device using the electronic identification number to convey information to the emergency response system.

As further described, the invention includes the combination of RF data and signal transmission with telephone land line communication in a home-based device for emergency and convenience communications. This summary is of only some of the broader aspects of the invention and is provided to generally inform about the nature of the invention and is not in any way limiting to the scope of the invention as defined by the claims and equivalents thereof.

### BRIEF DESCRIPTION OF THE DRAWINGS

FIG. 1 is a schematic block diagram of the emergency communication system of the invention;

FIG. 2 is a schematic block diagram of interactions between components of the emergency communication system of the invention;

FIG. 3 is a schematic block diagram of inputs to and outputs from a base reception and transmission (transceiver) device of the emergency communication system of the invention;

FIG. 4 is a schematic block diagram showing the flow of the broadcasting of an emergency signal through an emergency response system of the emergency communication system of the invention; and

FIG. 5 is diagram of a representative reception and transmission (transceiver) device of the emergency communication system of the invention.

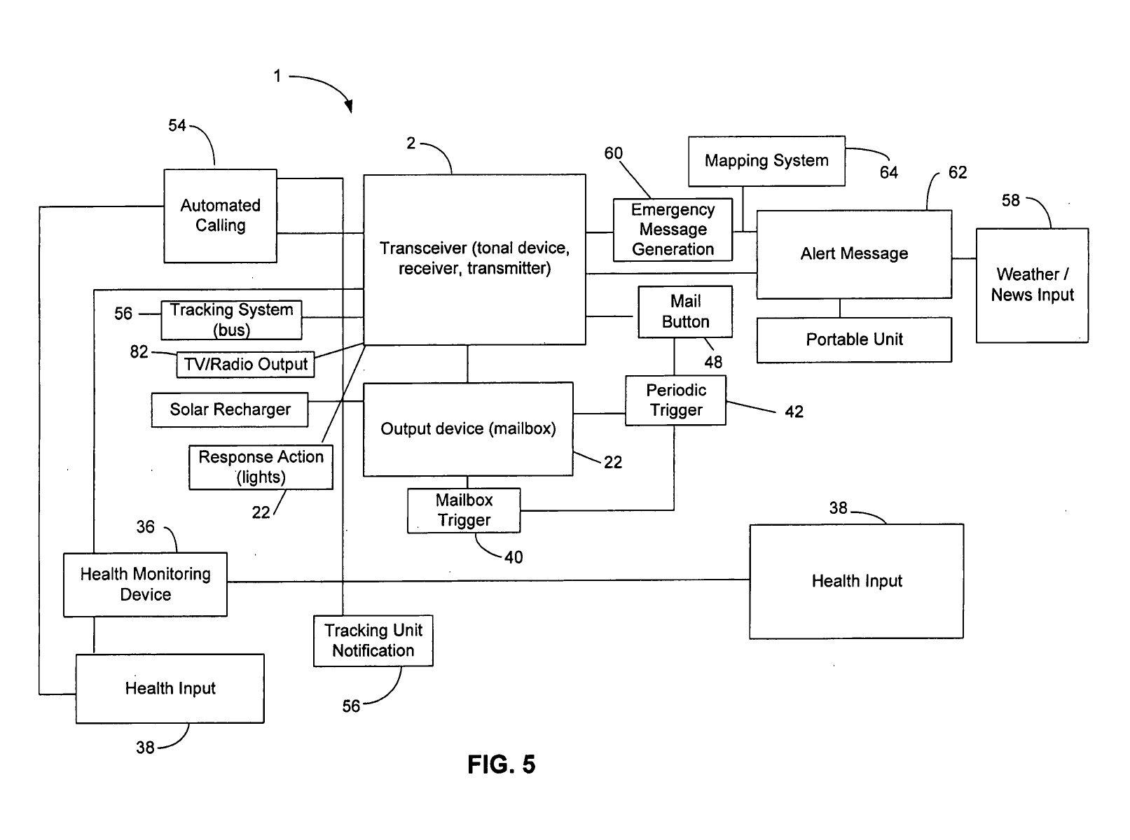

### DETAILED DESCRIPTION OF THE INVENTION

The present invention relates to an emergency communication system with two way communication ability. The user at a residence or place of business being able to transmit information to a network via a standard phone line and to receive information into the residence or place of business via radio frequency (RF) signals. The two way communication nature allows for maximum communication in the event of an emergency and allows the timely transfer of data in situations where such a transfer is crucial. Providing such information to emergency response personnel prior to the arrival at the scene of an emergency allows the personnel additional time to prepare the response and reduces the amount of time needed to assess/diagnose the situation.

### Combined Telephone and RF Communication

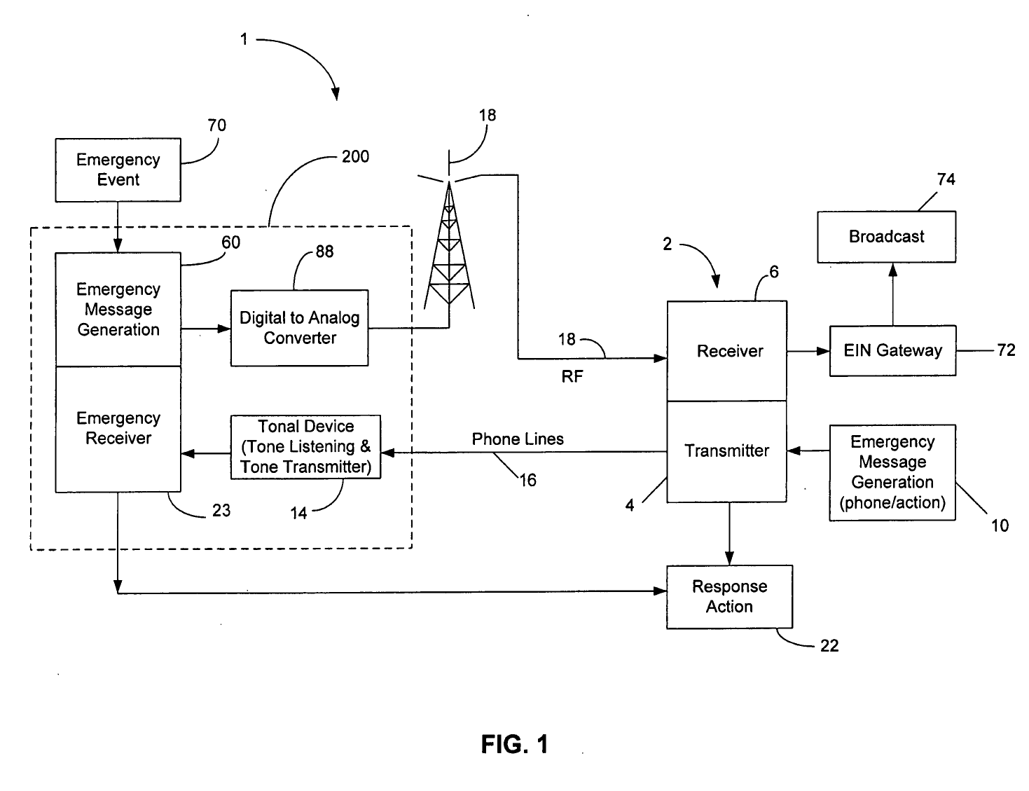

The emergency communication system 1 (FIG. 1) provides an inexpensive method for the distribution of emergency data to a wide range of people in a community as it utilizes existing phone lines 16 and available radio frequencies (RF) 18. The usage of the system 1 is for both residential and business use, and as stated previous involves a two way communication of information in two different modes, each of which is universal and widely available. The emergency communication system 1 is schematically represented in FIG. 1. The residential/commercial part of the system is a transceiver device 2 located inside a residence or place of business which functions to relay information via a transmitter 4, primarily by a wired telephone network, and receive information via a receiver 6, primarily via RF transmission. The transceivers 2 are typically placed at multiple businesses/residences throughout a community or within a defined geographic area. The public safety entity in a township/city/county/community may decide to purchase transceiver 2 units for members of the community or the units can be individually purchased by residents or businesses. Typically a subscription to link the unit into the emergency communication system 1 is needed, however this is optional based on a community preference.

The emergency communication system 1 further includes an emergency response system 200 which performs communication and coordination of emergency response and community notification functions. Thus there are two primary functions of the emergency response system 200: the receipt of emergency messages, represented by emergency message receiver 23 (or “emergency receiver 23”), and the generation and transmission of emergency messages, represented by emergency message generation 60. In one embodiment, the emergency receiver 23 may include existing emergency message receipt systems, such as community 911 systems and affords dispatchers the ability to better diagnose the level of the problem presented. In addition, emergency personnel utilize unique features such as advanced mapping devices to aid in pinpointing and locating problematic areas in an emergency, as further described.

In the systems standard setup, in the case of a message being generated by an individual user, a residential or business user places an emergency call 10 to an emergency dispatch center or emergency message receiver 23 via a standard phone 12. Such a dispatch center/emergency message receiver 23 can be, but is not limited to, police, fire, poison control, hospitals or EMS (Emergency Medical Services). The emergency message receiver 23 has a tonal device 14 (a tone listening and a tone transmittal device). This tonal device 14 is connected to the phone system via a phone line 16. This phone line 16 can be, but is not limited to a standard phone line, a fax line, a PBX type phone line, or a cable line, based on the availability and needs of the user and/or the dispatch center/emergency message receiver 23. The tonal device 14 can be, but is not limited to, a modem. Based upon interpretation of the tonal signals received from the transmitter, the emergency message receiver 23 determines the level of emergency involved and issues a response action 22 accordingly. Signals are transmitted from the emergency message receiver 23 to the receiver 6 at the residence/business. The signals can be standard signals of RF 18 nature or can also be sent to the receiver 6 via standard phone lines 16. The various response actions 22 can be sent via RF signals 18, via the phone lines 16, or can be activated directly from the emergency response system 200 such as sending out a police or EMS vehicle. Another embodiment involves the two way transmission of signals via a cellular phone network. Another embodiment of data transmission involves the two transmission of signals via a wi-fi network (802.11a/b/g/n Ethernet wireless protocol). Another embodiment involves data transmission satellite communication networks such as satellite radio and satellite television networks.

### Network-controlled Emergency Lighting

Various outputs from the emergency response system 200 are possible, one such embodiment involves the sending of a signal to aid in locating the originating call. In this embodiment, after an emergency is determined, the emergency response system 200 sends a tonal signal back to the receiver 6. This signal creates an output at the users location via the transceiver 2. One output involves a response action 22 such as the illumination of a light or a set of lights to aid an emergency response crew in finding the emergency location. For example, after the user places the emergency call, the dispatch sends back a confirmation signal. This confirmation signal creates a response action 22 such as illuminating 27 a series of lights which have been placed outside the home, apartment of place of business. Examples of this include an illuminated address sign, a series of red lights detailing the address number, or a large red or white light placed upon a mailbox. The emergency response crew is able to quickly find the area of the emergency and eliminate time finding a location. Another option is generation of an audio tone to aid in a dual visual/audio response. Such a tone can be located as a speaker or beeper next to the illumination device. The user and/or the emergency dispatcher both possess the ability to control the audio/visual output based on their assessment of the situation and based upon the inputs received via the phone output. Power sources for these devices include, but are not limited to battery sources, standard AC/DC power and solar power.

Another capability of the transceiver 2 involves the ability to receive a signal to turn on one or more lights inside the users residence, this is accomplished by receiving an RF signal 18 at the transceiver, provided the device is setup to allow the action, then lights are turned on in the residence/business.

### Electronic Identification Number Matching Capabilities

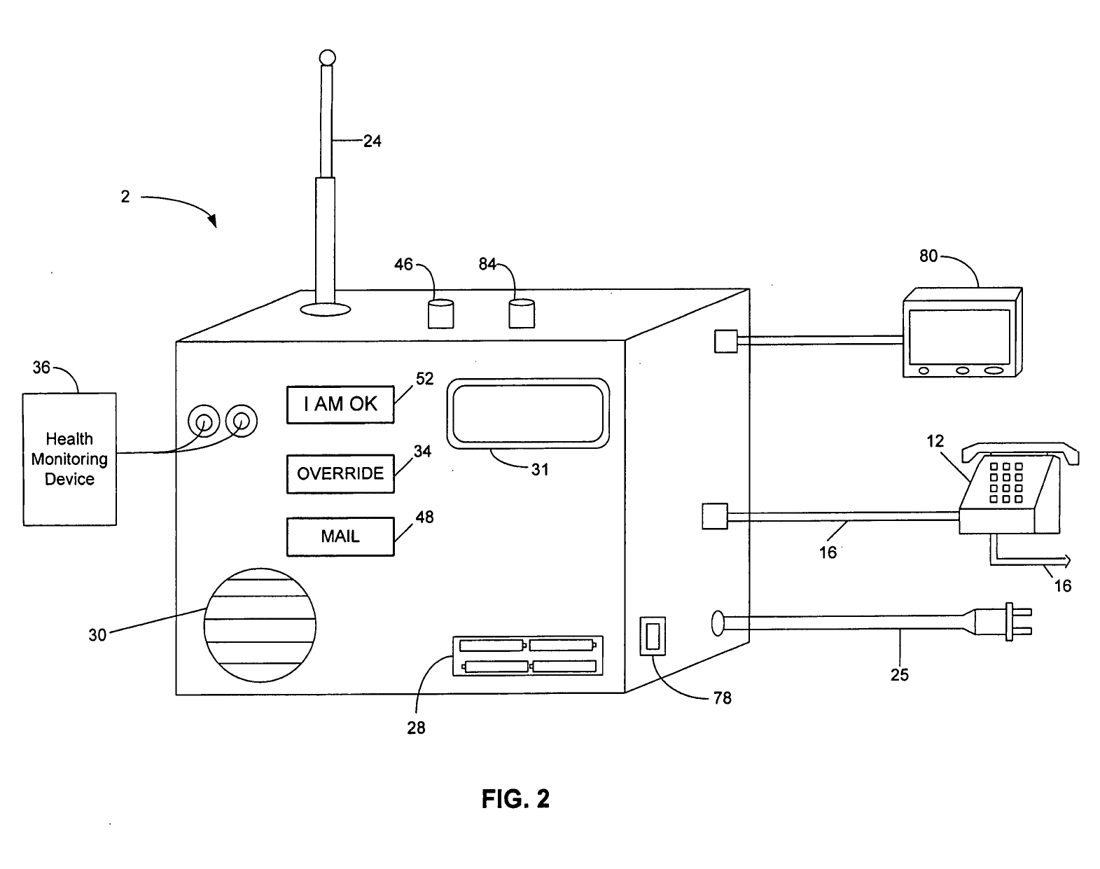

The residential/business portion of the emergency communication system 1 involves a one piece unit or transceiver 2 placed into a users residence or place of business. FIG. 2 details the transceiver unit and shows examples of the various input/output described herein. As shown in FIG. 1, the transceiver 2 contains a receiver 6 which accepts encoded messages sent via RF signals 18 to an attached antenna 24 or via a phone line 16; the transceiver 2 possessing the required decoding devices. The RF signals 18 can also be matched to a community-specific emergency system. The transceiver 2 containing the necessary RF matching circuitry to decode the RF signal 18 and containing the hardware to send signals/data via a phone line 16. Power is supplied to the unit via a standard 120V power 25 with battery power 28 as backup in case of power loss. In one embodiment transceiver 2 contains a speaker 30 able to broadcast messages or warning tones. In another embodiment transceiver 2 contains a screen 31 able to broadcast text message. In another embodiment transceiver 2 contains a screen 31 able to display messages via LED outputs. In another embodiment the transceiver 2 contains a screen 31 able to broadcast graphical output via a liquid crystal or plasma display. In another embodiment the transceiver 2 is able to link into a computer such as a desktop or laptop located in a home or business via a computer interface 78. The computer interface 78 providing additional programming capabilities and inputs/outputs to the user. The ability of the user to interact with a screen 31, a computer via a computer interface 78 or a tuner 80 such as a television, greatly aiding the user in terms of visual output. Such a visual output necessary for those with hearing impairments.

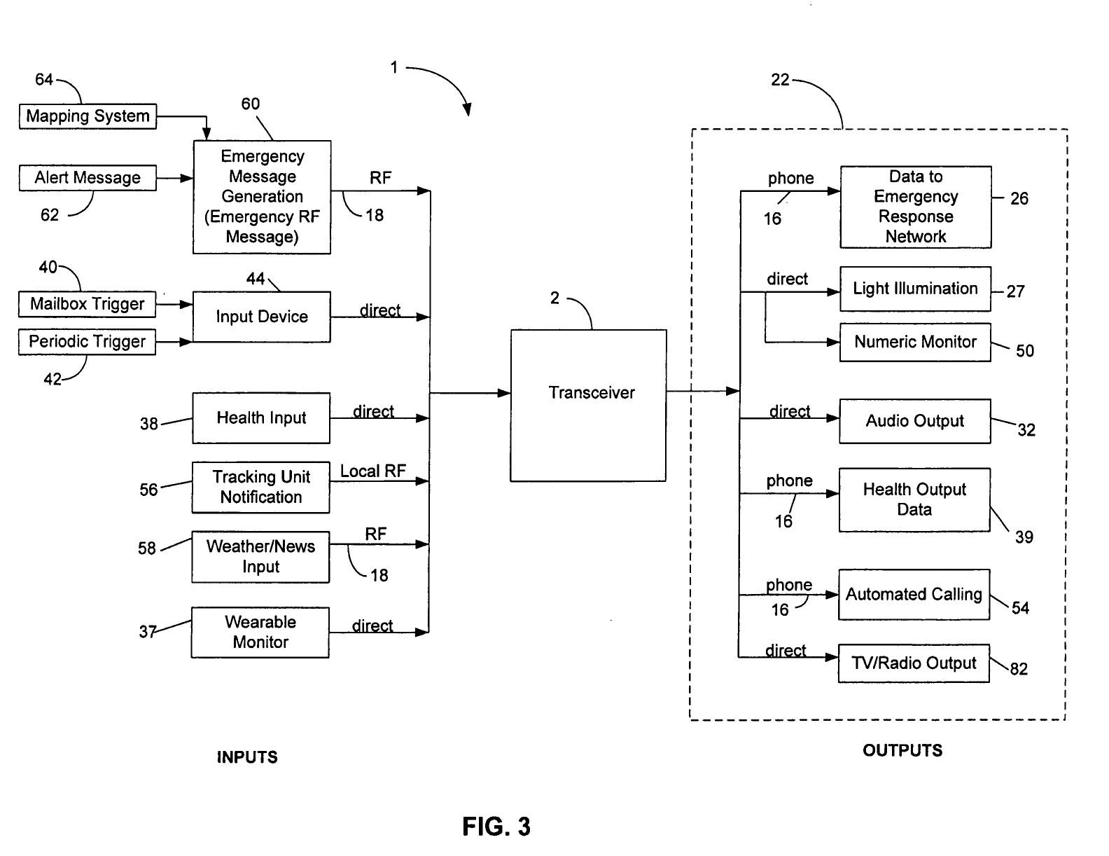

FIG. 3 details the input/outputs possible from the transceiver 2 unit, otherwise referred to as Response Actions 22. The transceiver 2 includes a text-to-speech synthesizer. The transceiver 2 accepts an input and processes an audio output 32 using the speech synthesizer. The speech synthesizer is able to broadcast an audible message under a variety of circumstances. One use includes the reception of an RF signal 16 from an emergency message receiver 23 (a community standard emergency response system) and its emergency message generation 60 capability. The emergency message receiver 23 includes a device able to broadcast the proper RF frequencies and codes. This reception then allows a voice response to broadcast from the transceiver 2 via speaker 30. For example, the notification of an incoming tornado could be instantly sent by community emergency message receiver 23 to owners/users of the transceivers 2. The notification broadcasting with the warning “Tornado Alert: please take cover, the tornado has been spotted at” and providing details of the event. The other use of the voice synthesizer involves the transceiver 2 automatically calling an outside person or source via the phone lines 16. Upon activation of a preset criteria, the transceiver 2 contacts a pre-programmed phone number or numbers and delivers a predetermined message which corresponds to or further communicates the emergency message such as 911. For example, when a phone call to 911 is made from transceiver 2, the transceiver 2 automatically initiates a subsequent call to the preprogrammed number(s) and delivers a digital voice synthesized message, such as “John Smith has called 911 to report a medical emergency”. This allows the pre-programmed contacts of the system user to be immediately notified of any emergency situations for which the transceiver 2 has been used.

In both examples, the incoming and outgoing messages must be matched via the transceiver's 2 unique electronic identification number (EIN) to ensure that proper messages are sent/received. This function is programmed with an EPROM. The EPROM is updated as needed by mailed upgrades or the internet. In the standard embodiment the EIN is programmed electronically during the transceivers manufacture and cannot be changed or altered. Changes/manipulation in the field are not possible. Upgrades or updates are not possible without a specifically coded upload. This EIN is broadcast with every transmission from the transceiver 2 and identifies from which transceiver 2 the transmission was sent. The EIN number being device specific and determined electronically at the factory. Each EIN may later be assigned to a phone number or an address, but the uniqueness of each transceiver 2 is based on the EIN originally assigned and not the current phone number, address or location of the transceiver 2.

As the system improves and upgrades are needed, changes to the transceiver 2 are possible via electronic and manual means. Each transceiver 2 is given its own unique unchangeable EIN, however the coding and response actions within each transceiver 2 are changed based on the users preferences. Such upgrades can be made via internet connections, via download over a standard phone line 16, by direct input from a computer via the computer interface 78, by direct input from a suitable uplink device, or by the user/owner of the transceiver via mailed upgrades such as new transceiver 2 chips/boards or new software to be downloaded via a computer interface 78. The upgrades and changes can be made based on overall system changes made to the emergency communication system 1, or can be upgrades to a specific module or response action 22, can be upgrades to the inputs to the transceiver 2 or can be upgrades to the emergency response system 200. The upgrade/update being based on the users preference and provided automatically or requiring user acknowledgement prior to upgrade/update. These electronic and manual means of update/upgrade also allowing for diagnostics to be performed on the transceiver 2. Diagnostics both locally and from remote locations being needed to ensure the transceiver 2 is working as expected. A log of all changes and diagnostic checks is kept in the transceiver 2 computer coding. In one embodiment changes/upgrades/diagnostics are performed routinely once per day, typically during a period of low activity such as while a user is sleeping.

Additional security or safety features of the transceiver 2 include a manual override 34 which allows a user to silence the box in the case of repeated warnings/messages. Once the appropriate message has been heard/received, the transceiver 2 can be silenced until updated messages are sent. The transceiver 2 also contains a selectivity mode which filters out unwanted messages. This selectivity mode matches a digital signal or an electronic identification number (EIN) for each system to verify that the message is a message it should display. Another term for this selectivity mode is an EIN gateway 72 which determines if a sent RF signal/message applies. For example, a person could decline notification of minor weather occurrences. Another example involves a person not desiring to enable the response action 22 of the visual lighting system 27 (such as on a mailbox), or would allow a different type of signal to be displayed.

Another example involves a community targeting a specific area and broadcasting a message based on geography, the EIN being registered to a specific location/geographic area. The customization aspects are based upon the users preferences and controlled by the user, in contact/communication with the emergency message receiver 23.

### Remote Home and Patient Monitoring

The described visual notification response action 22 can be, but is not limited to, a wired box containing a series of LED lights able to be illuminated 27 upon a set of criteria being reached. Such a device can be placed in a window or onto a mailbox. The power source for this device involving a solar source, with a rechargeable battery backup. The LED lights of the device arranged in a manner to spell out the units address number. Other methods of notification involve a single light which can intermittently blink to alert emergency personnel to the users location and/or an audible alarm as discussed previously. All of these units can be displayed in a manner that a passerby can visually see from an outside or public location.

The transceiver 2 can also be utilized in conjunction with a health monitoring device 36 as one embodiment of the transceiver 2 includes the ability to monitor the overall health of a user. The emergency communication system 1 employing the transceiver 2 is used in conjunction with various health monitoring devices 36 inside a users residence or place of business. This health monitoring device 36 is interconnected with the one piece unit and able to monitor vital health signs and provide health input 38. The health monitoring device 36 measures vital data such as, but not limited to, a persons heart rate, blood pressure, blood sugar and/or body temperature. Such a health monitoring device 36 would have the necessary medical monitors and in turn would transmit the data 38 to the transceiver 2. The user would submit to the variety of tests and the health input 38 data generated would be sent from the transceiver as health output data 39 to an emergency message receiver 23. The emergency response system 23 having a device that interprets the vital health data 38 being sent and using it to immediately assess the medical condition of the user. This immediate assessment allowing the responding medical personnel the ability to assess and diagnose a situation, prior to arrival at the scene of the emergency, with time being of increased importance in eliminating routine assessments. These assessments and response actions are provided to the personnel en route to the emergency.

One example of the tones generated by the health monitoring device 36 involve a series of tones transmitted to the tonal device 14 via a series of codes. These tones may vary based on system setup and the emergency response system 23 preferences. One such example is detailed in the following scenario as the data shown in the transmission sequence transmitted via tonal (or other) signals:
0-@@@@@ sign tones are generated which signify the start of a new transmission.
1—00:00:00 DD:MM:YY star tones are generated which signify the start of a new segment of an already initiated transmission, with this being the first transmission in a series, the health monitoring device 36 and the transceiver 2 generate an incident number which is comprised of four digit year, month, day, hours, minutes. An example being 200604121633.
1.1—@@@ tones are generated which signify start of a new segment of transmission.
2—H ### the letter H is representative of Heart and ### the three digit number signifying heart beats per minute (Example H085).
2.1 @@@ tones are generated which signify start of a new segment of transmission.
3—T### which is representative of temperature (Example T103).
3.1 @@@ tones are generated which signify start of a new segment of transmission.
4—B###/### which is representative of Blood Pressure (Example B102/087).
4.1 @@@ which representatives an end of transmission.

Another embodiment of the health monitoring system involves a wearable monitor 37. The wearable monitor 37 is worn on users person and can be similar to a wristwatch or worn around a users neck. The wearable monitor 37 is able to contact the transceiver 2 when the two are within proximity of one another. This proximity can be 100 yards, or 500 yards, or one mile or 5 miles in distance.

In one embodiment the wearable monitor 37 contains at least two buttons, one for notification to the transceiver 2 that the user is alright and not in need of assistance, and a second for notification to the transceiver 2 that assistance is needed. The user is able to notify the transceiver 2 that assistance is needed and the transceiver 2 follows a predetermined criteria in issuing a response action 22. The response action 22 can be an automated call 54 to an emergency service, an automated call 54 to 911, health output data 39 to an emergency service or any other predetermined response action 22. One example would involve an elderly person living alone using the device as a means of notifying a relative that the elderly person is in danger or in need of assistance and cannot reach a telephone, or unable to speak, but able to push a button on a wristwatch or necklace.

In another embodiment the wearable monitor 37 is again located on a users body and contains a communication means able to communicate with the transceiver 2. The wearable monitor 37 contains a microphone and speaker and allows two way communication between the wearable monitor 37 and the transceiver 2. In this embodiment the wearable monitor optionally contains the two buttons for remote signaling whether the users is in need of assistance or is not in need of assistance. In this example a user could notify the transceiver 2 of the need to place a phone call to a predetermined contact such as a relative or 911. The user could initiate the call by enabling the device via a button or switch and then the user would then have the ability to communicate to the contact via the wearable monitor 37 and the transceiver 2. The two way communication allowing both the user and the contact the ability to monitor the nature of the situation and the response action 22 needed.

Additional embodiments of the output utilize modifications to a users mailbox. In addition to the lighted address displays 27 as a response action 22, (which can be attached to a mailbox via a mounting bracket or Velcro) another usage is the use of a mailbox trigger 40. By attaching the appropriate hardware to a mailbox, one monitors the number of days a mailbox, or similar device, is (or is not) accessed. A movement sensor detects when a mailbox is opened or closed and sends a signal/input device 44 locally at the box and back to the transceiver 2. The transceiver 2 alerts via a visual light 46 and an audio message that the mail has been delivered. The user then presses the mail button 48 on the one piece unit acknowledging the mail delivery. If the user fails to acknowledge the mail delivery via the mail button 48 a notification is sent to the lighted display or numeric monitor 50 on the mailbox. In one example, failure by the user to acknowledge mail at the transceiver 2 for one day would result in the number 1 being lit on the mailbox numeric monitor 50. If a user fails to acknowledge for three days, the number 3 would appear in the mailbox numeric monitor 50. By displaying this number, an alert mail carrier or neighbor would be able to ascertain if the user was in danger. Such a unit is beneficial to an elderly or partially handicapped person who desires to live alone.

A similar device to the mailbox alert system involves a periodic trigger means 42 of letting the emergency communication system 2 and/or the transceiver 2 know that the user is OK. This is accomplished by a button 52 on the transceiver 2 which requires maintenance at a specified interval. For example, if the interval is to be twice a day, the user must press the button 52 on transceiver 2 at least twice per day. If the unit requires an periodic trigger 42 at 8 AM and 8 PM, then beginning at 8 AM the unit emits an audible alarm 32. This alarm 32 alerts the user to press the button 52 acknowledging that their health/well being is at an acceptable level. If the button 52 is not pressed the alarm 32 continues at increased volumes until either the button 52 is pressed or after a set period of time, the device enacts the automated calling 54 feature. The automated calling 54 automatically contacts a specified list of contacts. The contacts are dialed and a message delivered stating that the person at the residence has not pressed the button 52 at the required interval. The persons contacted via the automated calling 54 can then take the appropriate action. An additional response action 22 of lighting the sign outside the residence occurs to alert outside persons/neighbors.

### Locator and Proximity Sensing

The emergency communication system 1 also functions as a child (or elderly) monitoring system. By utilizing the transceiver 2 as a home base, one can place a monitoring or tracking device onto another person. When the person with the tracking device leaves the home base (near the transceiver 2) a tracking unit notification 56 is made to the emergency communication system 1. The person is then expected back within a specified time. Upon return, the transceiver 2 is notified and a phone call can be placed to a predetermined number alerting a person (such as a parent) that the person has returned. If the person does not return by a specified time, for example is two hours late, a warning call via the automated calling 54 to a predetermined number alerts the parent to this fact. Another feature includes a weather/news input 58 as the person leaves the residence or business. Such a report could alert the person to, but is not limited to, inclement weather or a traffic delay. Additional warnings and/or announcements/audio outputs 32 are possible, for example warning a parent of the evenings PTA meeting is possible. Another embodiment of this idea includes, instead of the transceiver 2 being the receiving/tracking unit, placing a receiving unit in the door jamb of the house, and acknowledging when the child pass through the door with the tracking unit.

### Emergency Broadcasting/Weather and Disaster Monitoring

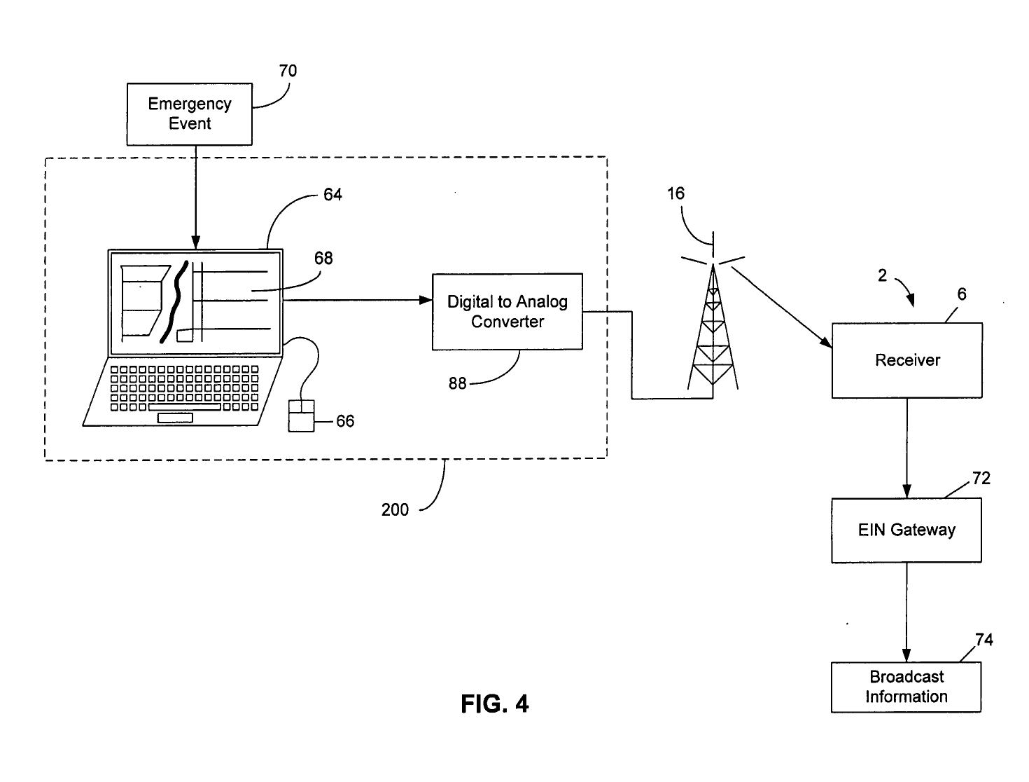

In the event of a need for significant emergency event 70 response the emergency response system 200 of the emergency communication system 1 has the ability to warn via an alert message 62 a community and assist in rescue/emergency efforts. The emergency responder first determines that an emergency 70 exists. Upon designation an emergency message generation 60 signal is issued. Such a signal first passes through an digital-to-analog converter 88, and upon conversion an RF signal 18 is broadcast via normal radio frequencies and frequencies specific to the electronic communications system 1. FIG. 4 details how emergency personnel access a mapping system 64 module which allows the emergency personnel to access a map of a city or a zone of interest. By mouse-clicking 66 (or using a screen pen) on the map 68, and submitting the appropriate password, the user can access the businesses and residences in an affected area. Based on the ability to access addresses, emergency personnel can choose to selectively advise and/or issue warnings to a specific address, street, city block or township/city. The map 68 has the ability to designate the areas of interest and allows emergency personnel to utilize the map 68 and make appropriate decisions. Once the decision is made, an RF signal 18 is sent to those areas and an alert message is broadcast to those individuals/systems. This signal is sent as a compressed data burst, the burst occurring during open times in the radio signal. Such a burst does not interrupt standard radio transmissions. The RF signal 18 is sent during open/free areas of data in the radio signal, saving band width for emergency information delivery and a more rapid/reliable data transfer.

Upon notification of a significant emergency event 70, the emergency communication system 1 also enacts an automatic calling feature. Such a feature immediately contacts key emergency manager such as mayors, fire, police, EMS workers and similar personnel. These personnel are contacted via their mobile and home numbers, immediately notifying all emergency response personnel who can lend assistance in a situation.

In the event of an emergency event 70, the following data is delivered to the emergency communication systems to immediately describe the situation and assist first responders in ascertaining the nature of the emergency. One such example is detailed in the following scenario as the data is shown in the transmission sequence:
{Type: #, City Code: ####, Zone: ###, County: ####, State: ##, Code: #####, Unit ID: ###.##########}
Type is either an emergency of non-emergency code of 0 or 1.
City code is comprised of up to 4 alpha numeric digits signifying a city name.
Zone is a 3 digit alpha numeric code assigned by a governmental agency.
County is a 4 digit alpha numeric code assigned by a governmental agency.
State is a 2 digit alpha numeric code assigned by a governmental agency
Code is a 4 digit alpha numeric code which is preset in the IBOX system via code recognition and a voice description of actions that need to be taken by the residence.
Unit ID is the Electronic Identification Number or unique number assigned to each communication system. The first 3 digits known as the master halt containing the universal code which functions as all outgoing messages to activate the communications systems, regardless of their unique numbers. The second series of numbers is the number assigned to a specific communication system. The system recognizes the code and relates this to each specific Electronic Identification Number. This code passing thru the EIN gateway 72 determining whether the message is broadcast 74 on the transceiver 2.

One option for the communication system involves the addition of a tuner device 80 for a television or a radio. Such a tuner 80 would deliver an emergency message via TV/radio output 82 to the television or radio after turning the unit on. If an initial emergency message is not acknowledge at the transceiver 2, the tuner 80 would turn on a radio or television and broadcast the message on that medium. The television and/or radio serving as a second means of broadcasting the message. Another variation on this method involves a light 84 which lights up once an emergency message is received. This serves as a further notification system that the user should acknowledge the message sent due to the messages importance. Another embodiment involves a screen 31 broadcasting the message directly on the transceiver 2 unit. Another embodiment involves a link to laptop or desktop computer via a computer interface 78. The laptop or desktop acting as an additional input/output device.

Another option for the communication system is the ability of an automated calling feature 54 for contacting a predetermined list of numbers. A list of numbers (in one embodiment ten are used) is programmed into the transceiver 2. Utilizing a computer, the user pre-programs a set of ten phone numbers listing each persons name, country code, city code, area code, phone number and message to be delivered. The message to be delivered is usually “immediate help is needed at 125 Market St.” The numbers given for delivery typically being relatives of the user and police/fire departments. This provides a list of contacts in the event of an emergency, with several numbers contacted in the event the first person is unreachable. The transceiver 2 using the automated calling feature 54 continually contacts the provided numbers until a viable connection is made.

In another embodiment using the health input system 38, the emergency communication system 1 includes health care applications with the addition of a wearable health monitoring device 36. Such a wearable system/device can be employed similar to a wristwatch or a necklace and allows the wearer the ability to contact the transceiver by pushing a button. This health input 38 notifies the emergency communication system 1 to begin a process of activating the automated calling feature 54 and notifying a list of contacts to be called in such a situation. In another embodiment, the health monitoring device 36 device serves as a continuous monitoring system which monitors the heart rate of the user, whereupon the system is notified and a health input 38 given if the heart rate exceeds a set limitation. If this limitation is exceeded a slight vibration notifies the user of a problem. If the user is unable to or does not wish to override the notification, the unit proceeds to activate the automated calling feature 54 and notify the designated list of contacts. In another embodiment the unit sends the health output data 39 to the emergency response system 200.

Another embodiment of the emergency communication system 1 involves the ability to provide accurate data in an emergency 70. By monitoring the weather input 58 via a computer/internet or another means, or by monitoring the weather system via a portable weather station, weather input 58 data can be utilized in an emergency situation. In one embodiment, multiple weather sensors are located around a large city. From these placements, advisements are made regarding wind directions, wind velocity, temperature and/or moisture. Such data could be available in situations where weather has an effect on an emergency. An example of an emergency 70 would be a chemical spill or gas leak. In that example knowledge of wind direction is key to evacuation methods and determination of how many people to evacuate. Other disaster scenarios are possible including, but not limited to, hurricanes, thunderstorms, tornados, nuclear fallout, prisoner escape, amber alerts, homeland security threats and fire.

In this embodiment the emergency communication system 1 notifies via radio frequency (RF) 18 the nature and extent of the emergency 70. In addition the radio frequency (RF) 18 broadcasts 74 possible evacuation routes. By linking this data into a computerized system the emergency communication system 1 advises routes and aids in printing out auto decals for emergency personnel, allowing the appropriate personnel into the emergency zone. In addition, the emergency communication system 1 provides passwords to appropriate personnel and faxes maps. Finally, the system notifies local hospitals/doctors and provides information regarding the nature of the injuries and nature of the emergency 70 prior to a patient even arriving at an emergency facility. This information aids hospital personnel regarding the immediate action to take/or not to take.

During a disaster, power outages are possible and/or portability of the unit is key. The emergency communication system 1 addresses both of these issues. Specifically the emergency dispatch center 20 portion of the emergency communication system 1 performs as a remote station. Such a station is enclosed in a device resembling a briefcase and is transportable. Such a system is utilized in a remote location or at or near the scene of an emergency. A set of rechargeable batteries is necessary to run the device in the event 120V power is not accessible.

What is claimed is:

1. An emergency communication system comprising:
a transceiver for sending information from a location to an emergency response system;
the transceiver being connected to a standard phone network;
the transceiver operative to send signals over a standard phone network to the emergency response system;
the transceiver further comprising a receiver for receiving information via radio frequency signals, the transceiver having a unique electronic identification number;
the emergency response system also having the unique electronic identification number and operative to send radio frequency signals to the transceiver;
the transceiver using the electronic identification number in determining the relevancy of radio frequency signals received from the emergency response system;
the transceiver generating a response action when relevant radio frequency signals are received from the emergency response system; and
the transceiver further operative to transmit information to the emergency response system combined with the electronic identification number.

2. The system of claim 1 wherein the emergency response system includes a digital to analog converter.

3. The system of claim 1 wherein the transceiver includes an analog to digital converter.

4. The system of claim 1 wherein the transceiver includes a display means.

5. The system of claim 1 wherein the emergency response system includes:
a map;
a computer;
means for graphically selecting geographical areas on the computer;
means for determining business and residential addresses within a selected geographical area;
means of matching addresses within a selected geographical area to unique electronic identification numbers; and
means for determining if the transceiver received signals based on preprogrammed codes and the electronic identification number.

6. The system of claim 1 further comprising:
one or more lights operatively connected to the transceiver, the transceiver operative to control the lights based on reception of relevant radio frequencies from the emergency response system.

7. The system of claim 6 wherein:
the one or more lights are attached to a mailbox or a window;
the one or more lights are powered by batteries or a solar panel; and further comprising an audio output device.

8. The system of claim 1 wherein the transceiver further comprises a text to speech synthesizer.

9. The system of claim 1 further comprising an internet connection to the emergency response system to receive information updates based on a unique electronic identification number.

10. The system of claim 1 wherein the transceiver comprises an input means by which a user can control receipt of information and notifications from the emergency response system.

11. The system of claim 10 wherein the input means is a computer interface port to receive information updates based on a unique electronic identification number.

12. The system of claim 1 wherein the transceiver is connected to
a health monitoring device able to read a human's heart rate, blood pressure or temperature; and is operative to send heart rate, blood pressure or temperature data via the standard phone lines to the emergency response system.

13. The system of claim 12 wherein the human's heart rate, blood pressure or temperature data are sent via a series of unique tones.

14. The system of claim 1 wherein the transceiver further comprises an operative connection to:
a signaling device attached to a mailbox, the signaling device operative to monitor when the mailbox is open, illuminate and count each time the mailbox is not opened, and send a notification to the emergency response system if the mailbox is not opened within a predetermined amount of time.

15. The system of claim 1 wherein the transceiver further comprises:
an input device, the input device requiring a periodic interaction at a preset interval; and the input device operative to send notification to the emergency response system if the periodic interaction does not occur within the preset interval.

16. The system of claim 15 wherein the notification includes the illumination of a light outside a residence.

17. The system of claim 15 wherein the notification includes the use of a speech synthesizer to deliver a prerecorded message to one or more preset phone numbers.

18. The system of claim 1 wherein time and weather data are received from the emergency response system and replayed by an audio output of the transceiver.

19. The system of claim 1 wherein the transceiver is operative to receive alert messages from the emergency response system.

20. The system of claim 1 further comprising:
an interactive map accessible by the emergency response system;
the interactive map capable of highlighting geographic areas, providing addresses of all business and residences within a highlighted geographic area, and matching addresses in the highlighted area to corresponding electronic identification numbers of transceivers within the highlighted geographic area;
the emergency response system operative to send data to transceivers within a highlighted geographic area.

21. The system of claim 20 wherein data is sent by the emergency response system to transceivers during periods of inactivity on the radio frequency used.

22. The system of claim 20 wherein the transceiver is operative to send confirmation of receipt of data from the emergency response system to the emergency response system.

23. The system of claim 20 wherein the data is sent by the emergency response system to emergency response personnel within a highlighted geographic area.

24. The system of claim 1 further comprising a device attached to a television/radio which delivers a signal generated by radio frequency signals and provides a message on the television/radio.

25. The system of claim 1 wherein the transceiver further comprises a light which illuminates when an radio frequency signal is received from the emergency response system.

26. The system of claim 1 further comprising;
a tracking unit,
a means for determining when the tracking unit is within a set proximity to a second tracking unit; and
means for generating a notification signal that the tracking unit is within the set proximity and sending the notification signal to a transceiver.

27. The system of claim 26 wherein the notification signal is a audio message sent to a phone number which corresponds to a transceiver.

28. The system of claim 1 further comprising a database of phone numbers to be contacted by the system upon the occurrence of a predetermined event at the location of a transceiver;
the system operative to deliver an informational message via telephone network connection to one or more transceivers, and to automatically contact pre-identified emergency service personnel.

29. The system of claim 1 further comprising:
a health monitoring device worn by a user and operative to measure the user's heart rate and signal the transceiver in the event a measured heart rate exceeds a preset value, the transceiver programmed to notify the emergency response system upon receipt of a signal from the health monitoring device.

30. The system of claim 29 wherein the health monitoring device has a manual override.

31. The system of claim 1 further comprising:
a wearable monitor able to be transported and able to accept input by the user and further able to communicate the input to the transceiver via RF signals.

32. The system of claim 1 wherein the emergency response system further comprises:
a weather monitoring system;
the weather monitoring system tracking one or more of temperature, wind speed, wind direction, humidity, rainfall, or barometric pressure; and
the weather monitoring system being used to assess an emergency situation and broadcast a message which corresponds to an emergency situation.

33. The system of claim 32 wherein the system includes:
a mapping device to assist in planning evacuations routes; and
a printer for the printing of decals to affix to vehicles.

34. The system of claim 32 wherein the system alerts medical and emergency response personnel of the temperature, wind speed, wind direction, humidity, rainfall, or barometric pressure and provides this information to assist in the emergency.

35. The system of claim 1 wherein the data transmittal means is portable and operable via battery power.

36. The system of claim 1 further comprising an alarm panel located inside a residence or building, the alarm panel activating an alarm via the transmitter device if the alarm exceeds a set range.
